(19) United States
(12) Patent Application Publication
(10) Pub. No.: US 2025/0196656 A1
(43) Pub. Date: Jun. 19, 2025

(54) TORQUE CONTROL APPARATUS AND METHOD IN DRIVE SYSTEM OF ELECTRIC VEHICLE

(71) Applicants: Hyundai Motor Company, Seoul (KR); Kia Corporation, Seoul (KR)

(72) Inventors: Jiwon OH, Hwaseong-si (KR); Ho Wook LEE, Seoul (KR); Jeong Soo EO, Hwaseong-si (KR)

(21) Appl. No.: 18/665,766

(22) Filed: May 16, 2024

(30) Foreign Application Priority Data
Dec. 19, 2023 (KR) 10-2023-0185329

(51) Int. Cl. B60L 15/20

(52) U.S. Cl. CPC B60L 15/20; B60L 2240/423; B60L 2240/48; B60L 2250/28; B60L 2260/20

(57) ABSTRACT

A torque control apparatus in an electric vehicle includes a driving information detector that detects information indicating a vehicle driving state, a controller that generates a motor torque command for satisfying a demand torque based on vehicle driving information including the detected information, and a motor that is controlled according to the generated motor torque command. The controller determines whether there is a virtual shift demand according to the vehicle driving state in a drift mode, stops, when there is the virtual shift demand, determination and generation of a shift intervention torque for implementing a virtual shift feeling and determines a motor torque as a value that varies with a slope from a target torque before shift to a target torque after shift during virtual shifting in the drift mode, and generates the motor torque command using the determined motor torque as a command value.

### CROSS-REFERENCE TO RELATED APPLICATION

This application claims, under 35 U.S.C. § 119 (a), the benefit of priority from Korean Patent Application No. 10-2023-0185329 filed on Dec. 19, 2023, the entire contents of which are incorporated herein by reference.

### TECHNICAL FIELD

The present disclosure relates to a torque control apparatus in a drive system of an electric vehicle, capable of implementing specialized virtual shifting in a drift mode, in the electric vehicle capable of performing both a virtual shift mode and the drift mode, and a method thereof.

### BACKGROUND

Recently, an electric vehicle market is gradually expanding. In an electric vehicle, most of the technical bottlenecks in an internal combustion engine vehicle, such as responsiveness, fuel efficiency, and exhaust gas regulations, have been resolved, which increases the possibility of developing various new technologies. Accordingly, unlike the development paradigm of the internal combustion engine vehicle, securing a USP (unique selling point) through expanded functions in the electric vehicle market is emerging as the biggest factor in the competitiveness of electric vehicles in the future.

In particular, as a USP to highlight driving fun, a virtual shifting function that provides a virtual shifting effect is becoming a new development consideration among automobile manufacturing brands.

In addition, a drift mode for implementing functions specialized for driving fun such as drift using characteristics of an electric vehicle with a high degree of freedom in driving force control has been developed as one factor of the USPs that can be appealing from a marketing perspective.

The drift mode is a known technique in the electric vehicle. In the case of an AWD (All Wheel Drive) vehicle, this technique includes a strategy for providing a comfortable environment for a driver by stopping tire slip control intervention, generating a driving force only by a rear-wheel motor, and generating rear-wheel slip using a method of engaging an e-LSD (electronic-limited slip differential).

Further, unlike an internal combustion engine vehicle, an electric vehicle does not use a multi-speed transmission, and instead, a reducer with a fixed gear ratio is placed between a motor and driving wheels. This is because, unlike an internal combustion engine (ICE), which has a wide distribution range of energy efficiency according to an operating point and can provide high torque only in a high-speed range, in the case of a motor, the difference in efficiency according to the operating point is relatively small, and low speed and high torque can be achieved using characteristics of the motor alone.

In addition, a vehicle equipped with a conventional internal combustion engine drive system requires an oscillator such as a torque converter or a clutch due to the characteristics of the internal combustion engine that cannot be driven at low speed, but in a drive system of an electric vehicle, since its motor has characteristics of easy driving at low speed, the oscillator is not necessary.

Further, unlike torque of the internal combustion engine generated by aerodynamic and thermodynamic reactions, torque of the electric vehicle is generally precise, smooth, and responsive compared with the torque of the internal combustion engine.

Due to these mechanical differences, unlike the internal combustion engine vehicle, the electric vehicle can provide smooth driving without interruption due to gear shifting. However, the absence of the transmission in the electric vehicle is advantageous in that it provides smooth driving without interruption due to gear shifting, but for drivers who want the fun of driving, the absence of mechanical elements such as a transmission and the absence of a shift feeling may cause boredom.

Accordingly, in the electric vehicle that does not have the multi-speed transmission, there is a demand for a technique that allows a driver to feel driving emotion, fun, excitement, and direct connection provided by the vehicle equipped with the multi-speed transmission.

In particular, when the driver wants to feel the driving emotion, fun, excitement, and direct connection provided by the engine, transmission, clutch, and the like, it is desirable to provide a function to implement virtual drivability so that the driver can variously experience desired emotions in the same vehicle without replacing the vehicle.

A currently known technique for the virtual shift function is not to set a torque range of a motor to an entire currently available motor torque range, but includes a strategy for determining a virtual gear shift step according to vehicle driving conditions and varying a torque range according to the determined virtual gear shift step, and calculating, implementing, and expressing a virtual engine speed (RPM) and its range by applying a gear ratio for each virtual gear shift step.

On the other hand, during the drift mode operation alone, rear-wheel slip may be generated very easily. However, it is not easy to control the amplitude of the generation to the extent desired by a driver. This is because, due to characteristics of an electric vehicle, torque response is very fast and a torque generation range is set to the entire available motor torque range.

The reason why the above-mentioned problem does not occur in the internal combustion engine vehicle is because most internal combustion engine vehicles are actually equipped with a multi-step transmission, and a driver can select a desired torque range and engine speed range through appropriate shifting in drift driving.

In consideration of the above-mentioned background, the shortcomings of the drift mode in a typical existing electric vehicle may be very easily compensated for through the virtual shifting function. However, on the contrary, a shift intervention torque for generating and providing the virtual shift feeling in the virtual shifting function generates torque unrelated to a driver's intention during the drift mode operation, which may lower the ease of drift control.

Accordingly, it is desirable to provide a torque control method capable of solving the above problems. Further, a specialized drive system torque control method may be necessary when both the drift mode and the virtual shift function are in operation.

### SUMMARY

In one aspect, the present disclosure provides a torque control apparatus in a drive system of an electric vehicle including a driving information detector that detects information indicating a vehicle driving state, a controller that generates a motor torque command for satisfying a demand torque on the basis of vehicle driving information including the information detected by the driving information detector, and a motor that is controlled according to the motor torque command generated by the controller, in which the controller determines whether there is a virtual shift demand according to a vehicle driving state in a drift mode where the vehicle travels in a drift state, stops, in a case where a determination is made that there is the virtual shift demand, determination and generation of a shift intervention torque for implementing a virtual shift feeling and determines a motor torque as a value that varies with a slope determined on the basis of the vehicle driving state from a target torque before shift to a target torque after shift during virtual shifting in the drift mode, and generates the motor torque command using the determined motor torque as a command value.

In some implementations, the controller may control the slope of the motor torque by applying a slope limit or a filter, and determine a slope limit value or a filter constant value for controlling the slope of the motor torque from information on at least one of a shift progress rate, an accelerator position sensor value, a driver's demand torque, a gear shift step before virtual shift, and a gear shift step after virtual shift.

In some implementations, in the virtual shifting process, in a state where the motor torque is maintained at the target torque before shift, in a case where there is a change in the accelerator position sensor value, the controller may change the motor torque from the target torque before shift to the target torque after shift according to the slope determined on the basis of one of an accelerator position sensor value and a driver's demand torque.

In some implementations, the controller may control the slope of the motor torque by applying a slope limit, and determine a slope limit value for controlling the slope of the motor torque to decrease as the accelerator position sensor value increases, or to decrease as the amount of change in the accelerator position sensor value or a slope of the accelerator position sensor value decreases.

In some implementations, the controller may control the slope of the motor torque by applying a slope limit, and determine a slope limit value for controlling the slope of the motor torque to decrease as the driver's demand torque increases, or to decrease as the amount of change in the driver's demand torque or a slope of the driver's demand torque decreases.

In some implementations, the controller may change the motor torque from the target torque before shift to the target torque after shift according to a slope determined on the basis of the amount of rear-wheel slip.

In some implementations, the controller may control the slope of the motor torque by applying a slope limit or a filter, and determine a slope limit value or a filter constant value for controlling the slope of the motor torque to decrease as the amount of rear-wheel slip decreases, in the case of upshift, and to decrease as the amount of rear-wheel slip increases, in the case of downshift.

In some implementations, the controller may control the slope of the motor torque by applying a slope limit or a filter, and determine a slope limit value or a filter constant value for controlling the slope of the motor torque to increase as a change rate of the amount of rear-wheel slip increases in a positive (+) direction, in the case of upshift, and to decrease as the change rate of the amount of rear-wheel slip increases in the positive (+) direction, in the case of downshift.

In some implementations, the controller may control the slope of the motor torque by applying a slope limit or a filter, and determine a slope limit value or a filter constant value for controlling the slope of the motor torque to decrease as a change rate of the amount of rear-wheel slip increases in a negative (−) direction, in the case of upshift, and to increase as the change rate of the amount of rear-wheel slip increases in the negative (−) direction, in the case of downshift.

In another aspect, the present disclosure provides a torque control apparatus in a drive system of an electric vehicle including a driving information detector that detects information indicating a vehicle driving state, a controller that generates a motor torque command for satisfying a demand torque on the basis of vehicle driving information including the information detected by the driving information detector, and a motor that is controlled according to the motor torque command generated by the controller, in which the controller determines whether there is a virtual shift demand according to a vehicle driving state in a drift mode where the vehicle travels in a drift state, determines and generates, in a case where a determination is made that there is the virtual shift demand, a shift intervention torque for implementing a virtual shift feeling from the vehicle driving information, determines a drift mode-dedicated weight according to input information for each virtual shifting situation, applying the determined drift mode-dedicated weight to the generated shift intervention torque to determine a drift mode-dedicated shift intervention torque, and determines and generates the motor torque command on the basis of a driver's demand torque and the determined drift mode-dedicated shift intervention torque.

In still another aspect, the present disclosure provides a torque control method in a drive system of an electric vehicle including determining, by a controller, whether there is a virtual shift demand according to a vehicle driving state in a drift mode where the vehicle travels in a drift state, stopping, by the controller, in a case where a determination is made that there is the virtual shift demand, determination and generation of a shift intervention torque for implementing a virtual shift feeling, and determining a motor torque as a value that varies with a slope determined on the basis of the vehicle driving state from a target torque before shift to a target torque after shift during virtual shifting in the drift mode, and generating, by the controller, a motor torque command that uses the determined motor torque as a command value, and controlling a motor that drives the vehicle according to the generated motor torque command.

In some implementations, the controller may control the slope of the motor torque by applying a slope limit or a filter, and determine a slope limit value or a filter constant value for controlling the slope of the motor torque from information on at least one of a shift progress rate, an accelerator position sensor value, a driver's demand torque, a gear shift step before virtual shift, and a gear shift step after virtual shift.

In some implementations, in the virtual shifting process, in a state where the motor torque is maintained at the target torque before shift, in a case where there is a change in the accelerator position sensor value, the controller may change the motor torque from the target torque before shift to the target torque after shift according to the slope determined on the basis of one of an accelerator position sensor value and a driver's demand torque.

In some implementations, the controller may control the slope of the motor torque by applying a slope limit, and determine a slope limit value for controlling the slope of the motor torque to decrease as the accelerator position sensor value increases, or to decrease as the amount of change in the accelerator position sensor value or a slope of the accelerator position sensor value decreases.

In some implementations, the controller may control the slope of the motor torque by applying a slope limit, and determine a slope limit value for controlling the slope of the motor torque to decrease as the driver's demand torque increases, or to decrease as the amount of change in the driver's demand torque or a slope of the driver's demand torque decreases.

In some implementations, the controller may change the motor torque from the target torque before shift to the target torque after shift according to a slope determined on the basis of the amount of rear-wheel slip.

In some implementations, the controller may control the slope of the motor torque by applying a slope limit or a filter, and determine a slope limit value or a filter constant value for controlling the slope of the motor torque to decrease as the amount of rear-wheel slip decreases, in the case of upshift, and to decrease as the amount of rear-wheel slip increases, in the case of downshift.

In some implementations, the controller may control the slope of the motor torque by applying a slope limit or a filter, and determine a slope limit value or a filter constant value for controlling the slope of the motor torque to increase as a change rate of the amount of rear-wheel slip increases in a positive (+) direction, in the case of upshift, and to decrease as the change rate of the amount of rear-wheel slip increases in the positive (+) direction, in the case of downshift.

In some implementations, the controller may control the slope of the motor torque by applying a slope limit or a filter, and determine a slope limit value or a filter constant value for controlling the slope of the motor torque to decrease as a change rate of the amount of rear-wheel slip increases in a negative (−) direction, in the case of upshift, and to increase as the change rate of the amount of rear-wheel slip increases in the negative (−) direction, in the case of downshift.

In a further aspect, the present disclosure provides a torque control method in a drive system of an electric vehicle comprising determining, by a controller, whether there is a virtual shift demand according to a vehicle driving state in a drift mode where the vehicle travels in a drift state, determining and generating, by the controller, in a case where a determination is made that there is the virtual shift demand, a shift intervention torque for implementing a virtual shift feeling from vehicle driving information, determining, by the controller, a drift mode-dedicated weight according to input information for each virtual shifting situation, determining, by the controller, a drift mode-dedicated shift intervention torque obtained by applying the determined drift mode-dedicated weight to the generated shift intervention torque, and determining and generating, by the controller, a motor torque command on the basis of a driver's demand torque and the determined drift mode-dedicated shift intervention torque, and controlling, by the controller, an operation of a motor that drives the vehicle according to the generated motor torque command.

Other aspects of the disclosure are discussed infra.

It is to be understood that the term “vehicle” or “vehicular” or other similar terms as used herein are inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, vehicles powered by both electricity and gasoline.

The above and other features of the disclosure are discussed infra.

### BRIEF DESCRIPTION OF THE DRAWINGS

FIG. 1 is a block diagram showing an example of an apparatus that performs a drive system torque control process.

FIGS. 2 and 3 are diagrams illustrating an example of a drive system torque control state during virtual shifting in a non-drift mode where a drift mode does not operate in a drive system torque control method.

FIG. 4 is a diagram illustrating an example of a drive system torque control state during virtual shifting in the drift mode in the drive system torque control method.

FIGS. 5 and 6 are diagrams showing an example of the drive system torque control state during virtual shifting in the non-drift mode in the drive system torque control method.

FIG. 7 is a diagram illustrating an example of a drive system torque control state during virtual shifting in a drift mode in a drive system torque control method.

FIGS. 8 and 9 are diagrams illustrating an example of a drive system torque control state during virtual shifting in a drift mode in a drive system torque control method.

FIG. 10 is a diagram showing an example of the drive system torque control state during virtual shifting in the non-drift mode in the drive system torque control method.

### DETAILED DESCRIPTION

An electric vehicle can provide a driver of the electric vehicle with the same shift feeling as in an internal combustion engine vehicle equipped with an actual multi-speed transmission during driving.

Since the electric vehicle is not equipped with such a multi-speed transmission, the shift feeling that the driver can experience through the virtual shifting function in the electric vehicle is a virtual shift feeling that mimics the shift feeling of the internal combustion engine vehicle.

The virtual shifting function of the electric vehicle changes longitudinal acceleration of the vehicle using torque variability of a motor, and associates this change with a shift event, thereby allowing the driver of the electric vehicle to feel as if the driver is driving a vehicle equipped with a virtual transmission.

However, when a drift mode is operating, it is necessary to change the goal. In performing the drift mode, the priority is not to provide the shift feeling, but to improve the ease of drift control by providing a torque adjustment range desired by the driver.

Implementation and provision of the virtual shift feeling may be achieved through differentiation of a torque range for each shift step, which is one of characteristics of the virtual shifting function, but as another characteristic of the virtual shifting function, a shift intervention torque that is determined and reflected when performing shifting is different from a driver's demand torque, which may lower the ease of the drift control.

The background to this disadvantage is that a strategy for generating overall torque preferentially from a rear-wheel axle to facilitate occurrence of oversteer is used in the drift mode.

In other words, in a case where a lateral force occurs simultaneously when rear-wheel slip occurs, a difference in lateral forces provided by front and rear-wheels occurs, which generates a yaw moment of the vehicle. Accordingly, in consideration of characteristics of the drift mode for generating the oversteer, if an unintentional shift intervention torque acts on the rear-wheels to change the amount of the rear-wheel slip, it may affect the yaw moment, which may lower the ease of the drift control.

Accordingly, in order to solve such a problem, it is desirable to provide a technique of performing the virtual shifting function in the non-drift mode to generate a virtual shift feeling by reflecting the shift intervention torque in motor torque, and performing the virtual shifting function in the drift mode so that the transition of the torque range for each gear shift step is achieved without lowering the ease of drift control.

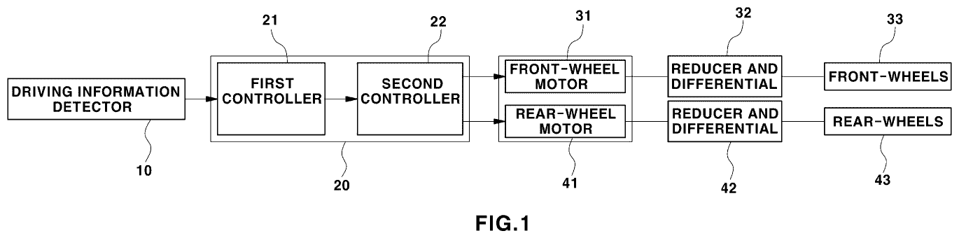

FIG. 1 is a block diagram showing a configuration of an apparatus that performs a drive system torque control process. The configuration of the apparatus will be described as follows.

The present disclosure may be applied to a vehicle in which front-wheels 33 and rear-wheels 43 are driven by independent drive units, respectively. Specifically, the present disclosure may be applied to a vehicle equipped with a front-wheel drive unit that applies torque to the front-wheels 33 and a rear-wheel drive unit that applies torque to the rear-wheels 43. The front-wheels 33 and the rear-wheels 43 are both driving wheels connected to the drive units for power transmission.

In addition, the present disclosure may be applied to a vehicle in which both the front-wheel drive unit and the rear-wheel drive unit are motors. In the following description, a motor 31 that is a front-wheel drive unit is referred to as a “front-wheel motor”, and a motor 41 that is a rear-wheel drive unit is referred to as a “rear-wheel motor”.

Referring to FIG. 1, the front-wheel motor 31 is connected to the front-wheels 33 for power transmission through a reducer and differential 32, and the rear motor 41 is connected to the rear-wheels 43 for power transmission through a reducer and differential 42.

In the following description, a front-wheel torque command and a rear-wheel torque command are torque (front axle torque and rear axle torque) commands for respective axles, which mean torque commands for the respective motors 31 and 41 that drive the vehicle, that is, a front-wheel motor torque command that is a torque command for the front-wheel motor 31 and a rear-wheel motor torque command that is a torque command for the rear-wheel motor 41, in which torque in an acceleration direction and torque in a motor driving direction are positive (+) torques, having a positive (+) value.

In addition, a braking torque includes a regenerative torque caused by the front-wheel motor 31 and the rear-wheel motor 41 and a friction braking torque caused by a friction brake system. Both the regenerative braking torque and the friction braking torque are torque in a deceleration direction, having a negative (−) value.

In a case where each torque value of the front-wheel torque command and rear-wheel torque command, which are torque commands for the motors 31 and 41, represents a negative (−) value, the command is a regenerative braking torque command for the corresponding motor, and the front-wheel motor torque and rear-wheel motor torque that have negative (−) values are torque in the deceleration direction and the regeneration direction.

Further, in a case where each torque value of the front-wheel torque command and the rear-wheel torque command represents a positive (+) value, the command is a driving torque command for the corresponding motor, and the front-wheel motor torque and rear-wheel motor torque that have positive (+) values are torques in the acceleration direction and the driving direction.

In some implementations, the vehicle's drive system includes a front-wheel drive unit and a rear-wheel drive unit. The front-wheel drive unit and the rear-wheel drive unit include driving elements such as a motor and driving wheels that drive the vehicle, a drive shaft, a reducer and differential, and an axle between the motor and the driving wheels, and the like.

That is, the front-wheel drive system includes the front-wheel motor 31, the front-wheels 33, a drive shaft between the front-wheel motor 31 and the front-wheels 33, the reducer and differential 32, and an axle, and the rear-wheel drive system includes the rear-wheel motor 41, the rear-wheels 43, a drive shaft between the rear motor 41 and the rear-wheels 43, the reducer and differential 42, and an axle.

Accordingly, torque output from the front-wheel motor 31 and the rear-wheel motor 41 in each drive system may be transmitted to the front-wheels 33 and the rear-wheels 43 through the drive system elements such as the drive shaft, the reducer and differentials 32 and 42, and the axles.

In addition, a battery is connected to the front-wheel motor 31 and the rear-wheel motor 41 via an inverter to enable charging and discharging. The inverter may include a front-wheel inverter for driving and controlling the front-wheel motor 31 and a rear-wheel inverter for driving and controlling the rear-wheel motor 41.

In the electric vehicle, operations (driving and regeneration) of the front-wheel motor 31 and the rear-wheel motor 41 are controlled according to a torque command generated by the controller 20. The controller 20 determines a demand torque on the basis of vehicle driving information obtained by the driving information detector 10 or the like, and determines front-wheel torque and rear-wheel torque, which are torques dividedly distributed from the demand torque. Then, the controller 20 generates and outputs, using the result as command values, torque commands for the respective motors, that is, a front-wheel torque command and a rear-wheel torque command.

Further, the controller 20 controls operations of the front-wheel motor 31 and the rear-wheel motor 41 through an inverter on the basis of the front-wheel torque command and the rear-wheel torque command. As described above, in a case where the front-wheel torque command and the rear-wheel torque command are positive (+) values, the commands may be defined as torque commands in the acceleration direction and the driving direction, and in a case where the front-wheel torque command and the rear-wheel torque command are negative (−) values, the commands may be determined as regenerative braking torque commands that are torque commands in the deceleration direction and the regeneration direction.

In some implementations, the controller 20 may include a first controller 21 that determines the demand torque necessary for vehicle driving on the basis of the vehicle driving information detected by the driving information detector 10, such as driver's driving input values, or receives the demand torque from other devices such as an ADAS (Advanced Driver Assistance System) controller, and generates and outputs the front-wheel torque command and the rear-wheel torque command, which are torque commands for the respective motors (respective axles), on the basis of the demand torque, and a second controller 22 that controls the operations of the front-wheel motor 31 and the rear-wheel motor 41 according to the front- and rear-wheel torque commands output by the first controller 21.

The first controller 21 may be a vehicle control unit (VCU) that determines and generates torque commands necessary for vehicle driving in a typical vehicle. Since methods and processes of determining the demand torque necessary for vehicle driving from the vehicle driving information and determining the torque command for controlling the torque of the drive system including the motor are well-known in the relevant technical field, detailed description thereof will be omitted.

In a case where the front-wheel torque command and the rear-wheel torque command are output from the first controller 21, the second controller 22 receives the same and controls the operations of the front-wheel motor 31 and the rear-wheel motor 41 through the front-wheel inverter and the rear-wheel inverter.

As a result, torque output by the front-wheel motor 31 is applied to the front-wheels 33 through the reducer and differential 32 of the front-wheel drive system, and torque output by the rear-wheel motor 41 is applied to the rear-wheels 43 through the reducer and differential 42 of the rear-wheel drive system.

The second controller 22 may be a typical motor control unit (MCU) that controls an operation of a driving motor through an inverter according to a torque command output from the vehicle control unit (VCU) in the electric vehicle.

In some implementations, vehicle driving information, indicating vehicle driving states, such as driver's driving input values input to the controller 20 may include sensor detection information that is detected by the driving information detector 10 and is input to the first controller 21 through a vehicle network.

Here, the driving information detector 10 may include an accelerator position sensor (APS) that detects a driver's accelerator position sensor value (APS value, %), a sensor that detects a drive system speed, and a sensor that detects a vehicle speed.

Here, the drive system speed may be rotational speeds of the front-wheel motor 31 and the rear-wheel motor 41, which are the driving motors, or rotational speeds (wheel speeds) of the driving wheels 33 and 43. Here, the sensor that detects the drive system speed may be a sensor that detects the rotational speed of each of the motors 31 and 41, and may be a typical resolver that detects a rotor position of the motor. Alternatively, the sensor that detects the drive system speed may be a typical wheel speed sensor that detects rotational speeds (wheel speeds) of the driving wheels 33 and 43.

Further, the sensor that detects the vehicle speed may also be the wheel speed sensor. Since a technique of obtaining vehicle speed information from a signal from the wheel speed sensor is well-known in the relevant technical field, detailed description thereof will be omitted.

As the vehicle driving information for determining and generating demand torque and a torque command in the first controller 21, the driver's accelerator position sensor value (APS value, %), the rotational speeds of the motor 31 and 41, the rotational speeds of the driving wheels 33 and 43, the vehicle speed, and the like, detected by the driving information detector 10, may be selectively used.

In addition, the vehicle driving information may include information determined by the controller 20 itself in a broad sense, and may further include information (for example, demand torque information) input to the controller 20 from another controller (for example, an ADAS controller) in the vehicle through the vehicle network.

In the above description, the control subject is divided into the first controller 21 and the second controller 22, but instead, the torque control process according to the present disclosure may be performed by a single integrated control element.

Each of a plurality of controllers integrated in the single control element may be referred to as the controller 20, and the torque control process according to the present disclosure to be described below may be performed by the controller 20. In the following description, the controller 20 is a controller that collectively refers to the first controller 21 and the second controller 22.

In the virtual shifting function, the torque range for each virtual gear shift step is differentiated, and this feature is convenient for the driver's drift control. However, the fact that the torque range for each virtual gear shift step is differentiated means that there is discontinuity in the torque range in performing shifting.

The torque discontinuity is a torque fluctuation that does not reflect a driver's intention, which may lower the ease of drift control. Accordingly, the present disclosure proposes a drive system torque control method capable of performing virtual shifting dedicated to the drift mode when the drift mode and the virtual shifting function operate simultaneously.

First, in some implementations, in the electric vehicle equipped with the virtual shifting system and capable of performing the virtual shifting function, in a case where there is a virtual shifting demand in a state where the vehicle is not currently in the drift mode, the controller determines and generates a shift intervention torque on the basis of real-time vehicle driving information for implementing a normal virtual shift feeling, reflects the result in motor torque, and controls the operations of the motors using the motor torque, in which the shift intervention torque is reflected as a command value, for implementing a virtual shift feeling. However, in a case where there is the virtual shift demand in a state where the vehicle is currently in the current drift mode, the generation and reflection of the above-mentioned shift intervention torque is stopped.

In this way, in a case where the virtual shifting is performed due to the virtual shifting demand during the drift mode operation, in order to ensure the ease of the drift control, the shift intervention torque is not generated, but instead, during a shift section, in implementing a torque change for solving the discontinuity problem in the torque range for each gear shift step, that is, a torque change from a target torque before shift to a target torque after shift, a method of controlling a slope of the motor torque change using a slope limit (rate limit) or a filter is used, so that the motor torque is changed slowly on the time axis.

Here, a slope limit value or a filter constant value in the shift section may be determined from a current vehicle driving state by setting data previously input and stored in the controller 20. That is, the slope limit value or the filter constant value may be determined by the setting data on the basis of a shift progress rate (%) to be described later, which is information indicating the vehicle driving state, an accelerator position sensor value (APS value, %), a demand torque according to driver's driving input, and information on at least one of a gear shift step before virtual shift and a gear shift step after virtual shift.

Here, the gear shift step before virtual shift and the gear shift step after virtual shift mean a gear shift step before shift (off-going gear step) and a gear shift step after shift is completed (on-coming gear step), based on one shift event.

The setting data defines in advance a correlation between input variables such as a shift progress rate, an accelerator pedal input value, and a demand torque, and at least one variable of the gear shift steps before and after virtual shift, and the slope limit value or the filter constant value, which is an output variable. Data in which the output variable is set to a value corresponding to the input variables may be used.

For example, a look-up table or a map in which the slope limit value or the filter constant value is set according to the shift progress, the accelerator position sensor value, the demand torque, and at least one of the gear shift steps before and after virtual shift may be used as the setting data.

The setting data is input and stored in advance in the controller 20, and may be used to determine the slope limit value or the filter constant value from the shift progress rate, the accelerator position sensor value, the demand torque, and at least one of the gear shift steps before and after virtual shift in the controller 20.

In addition, the setting data may be applied to all shift classes such as upshift, downshift, power-on, and power-off, which are virtual shift classes.

As described above, in the shift section during the drift mode operation, in addition to the method of not generating the shift intervention torque at all, a method of applying shift intervention torque dedicated to the drift mode, obtained by multiplying the existing shift intervention torque value by a weight dedicated to the drift mode, may be used.

In this case, as described above, since the weight must be applied so as not to lower the ease of drift control, a weight value between 0 and 1 preset according to input information for each virtual shifting situation may be used.

As in the case described above, “0” represents a case where the shift intervention torque is not used at all, and “1” represents a case where the shift intervention torque, which is used during virtual shifting in a state other than drift mode, is used itself. Accordingly, applying the weight between 0 and 1 can be understood as providing an appropriate compromise strategy between the two situations.

The input information for each virtual shift situation may be at least one piece of vehicle driving information including a gear shift step, a vehicle speed, an accelerator position sensor value (i.e., driver's pedal input value), a brake pedal position sensor value, and a steering angle.

To this end, the setting data, such as a table in which the drift mode-dedicated weight value between 0 and 1 is set according to the input information for each virtual shifting situation, may be input and stored in advance in the controller 20. After the drift mode-dedicated weight value corresponding to the input information for each virtual shift situation is determined by the setting data in the controller 20, a drift mode-dedicated shift intervention torque may be determined by multiplying the existing shift intervention torque value by the determined drift mode-dedicated weight.

In the above description, the shift progress rate (%) refers to a calculation value of a transition completion rate, in performing virtual shifting, when a virtual engine speed transitions from a virtual engine speed calculated with reference to the gear shift step before shift (current virtual gear shift step) to a virtual engine speed calculated with reference to the gear shift step after shift (target gear shift step).

More specifically, the shift progress rate (%) may be determined from the virtual engine speed. For example, in a case where a first speed that is a virtual engine speed before shift is to be changed to a second speed that is a virtual engine speed corresponding to a target shift step according to a shift demand, the shift progress rate may be determined according to the following Equation 1 using the first speed and the second speed together with the current virtual engine speed that is a real-time virtual engine speed in the shift section.

$$Shift progress rate ( \% ) = \{ ( current virtual engine speed - first speed ) / ( second speed - first speed ) \} \times 100$$

The shift progress rate at the time when shift starts may be 0%, and the shift progress rate at the time when shift is completed may be 100%. In a case where a shift event is to be canceled or another shift is to be performed during shifting, the gear shift step before shift and the gear shift step after shift (target gear shift step) are updated and a newly calculated shift progress rate value is used.

In the present disclosure, since a known virtual engine speed difference displayed on the vehicle after being determined in a typical virtual shifting system applied to the electric vehicle may be used as the virtual engine speed, detailed description of the method for determining the virtual engine speed in this specification will be omitted.

The virtual engine speed is used as a main variable necessary for generating and providing virtual effects such as a virtual shift feeling, virtual sound, and virtual vibration in a typical virtual shifting system or virtual sound system that virtually implements and provides the characteristics of the internal combustion engine vehicle in the electric vehicle. Further, in the electric vehicle, the virtual engine speed is one of main display information displayed on a cluster.

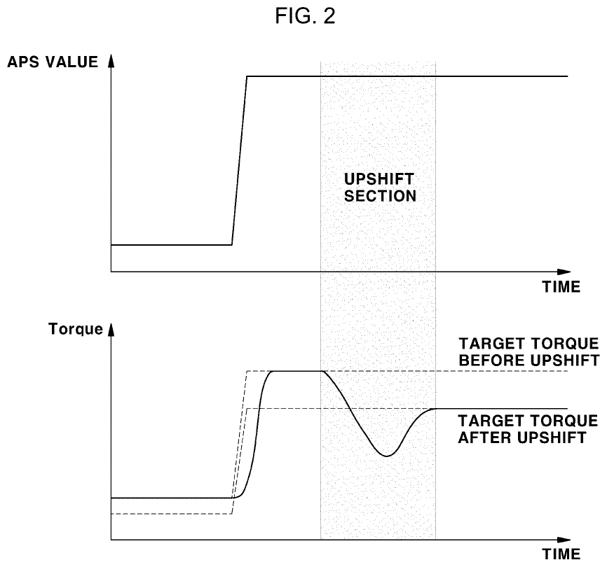

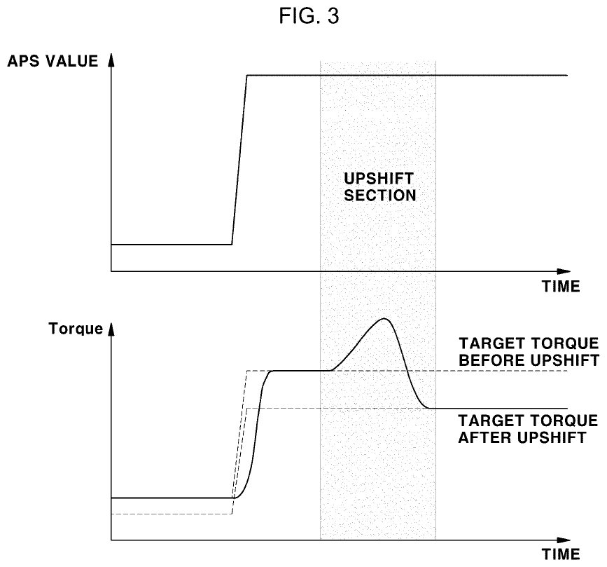

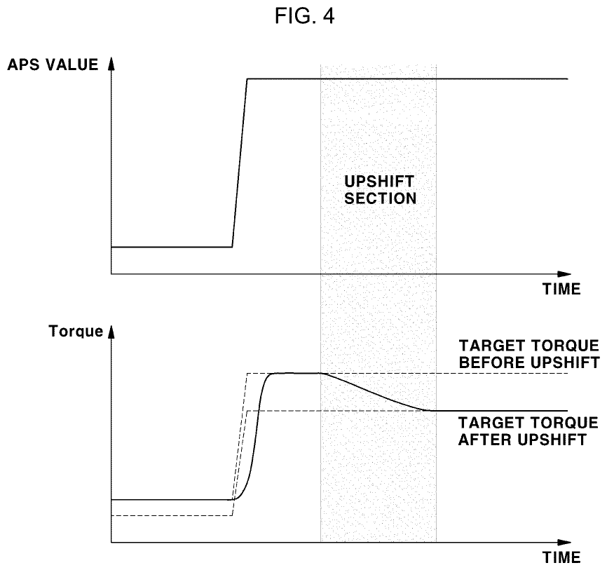

FIGS. 2 and 3 are diagrams illustrating a drive system torque control state during virtual shifting in a non-drift mode where the drift mode does not operate in a drive system torque control method. FIG. 4 is a diagram illustrating a drive system torque control state during virtual shifting in a drift mode in the drive system torque control method.

In each figure, an “APS value” represents a driver's accelerator pedal input value (%) detected by the accelerator position sensor of the driving information detector 10. In addition, in each figure, torque represents drive system torque, specifically, motor torque, and may be a command value of a torque command for controlling an operation of a motor that is a drive unit that drives the vehicle.

As shown in FIGS. 2 and 3, in the non-drift mode, the controller 20 may generate a motor torque command that uses the torque in which the shift intervention torque is reflected as a command value so that the motor generates the torque in which the shift intervention torque is reflected, in the virtual shift section. Here, in generating the torque necessary for vehicle driving through the motor, the controller 20 controls a torque output of the motor according to the motor torque command generated by correcting the motor torque using the shift intervention torque.

Here, the non-drift mode is a mode in which the drift mode does not operate, that is, a mode in which the drift control is not performed, and may be a mode other than the drift mode.

The control method for generating the virtual shift feeling in the non-drift mode may refer to a method disclosed in Korean Laid-open Patent Publication No. 10-2023-0120144 (Aug. 17, 2023) filed by the present applicant.

Specifically, in the non-drift mode, the control process performed by the controller 20 includes collecting real-time vehicle driving information during vehicle driving; determining virtual variable information including a virtual gear shift step on the basis of the collected real-time vehicle driving information; determining a torque range corresponding to a current virtual gear shift step in the determined virtual variable information; determining a driver's demand torque corresponding to a driver's driving input value in the real-time vehicle driving information within the determined torque range; determining, in a case where it is determined that there is a change in the virtual gear shift step, a shift intervention torque for generating a virtual shift feeling on the basis of the determined virtual variable information; determining and generating a final torque command on the basis of the determined driver's demand torque and shift intervention torque; and controlling an operation of a motor for driving the vehicle according to the generated final torque command.

Here, as shown in FIGS. 2 and 3, in the shift section, the final torque command that uses, as the command value, the driver's demand torque (motor torque) in which the shift intervention torque is reflected is determined, and the operation of the motor is controlled using the final torque command, so that the torque in which the shift intervention torque is reflected is output from the motor.

The virtual variable information may further include a virtual engine speed determined from a vehicle drive system speed or a vehicle speed in the real-time vehicle driving information, and the virtual engine speed may be determined as a value proportional to a value obtained by multiplying the vehicle drive system speed by a virtual gear ratio corresponding to a current virtual gear shift step, or a value proportional to a value obtained by multiplying the vehicle speed by the virtual gear ratio corresponding to the current virtual gear shift step.

In addition, in the controller 20, a torque range is set for each of a plurality of virtual gear shift steps. The torque range for each virtual gear shift step may be set so that the torque range is wider as the virtual gear shift step is lower.

In addition, in the controller 20, the width of the torque range, which is a difference between an upper limit value and a lower limit value of the torque range for each virtual gear shift step, may be determined in association with a predetermined virtual gear ratio value of a corresponding virtual gear shift step, and the upper limit value and the lower limit value of the torque range for each virtual gear shift step may be set as a value proportional to the determined virtual gear ratio value of the corresponding virtual gear shift step.

Further, the torque range of each virtual gear shift step may include a positive (+) torque range, and the driver's demand torque may be determined as a value corresponding to an accelerator position sensor value between the lower limit value and the upper limit value of the torque range.

Alternatively, the torque range of each virtual gear shift step may include a negative (−) torque range and a positive (+) torque range, and the driver's demand torque may be determined as a value corresponding to an accelerator position sensor value between the lower limit value and the upper limit value of the torque range.

In addition, in a case where it is determined that there is a change in the virtual gear shift step determined in the determination of the virtual variable information, the controller 20 uses the virtual gear shift step before the change as a current virtual gear shift step in the determination of the torque range.

Further, when determining the final torque command on the basis of the determined driver's demand torque and the shift intervention torque, the controller 20 sums the driver's demand torque and the shift intervention torque to determine the final torque command, and uses the determined final torque command as a torque command for controlling the operation of the motor.

Here, the final torque command is a torque command before being distributed to the front-wheel torque command (front-wheel motor torque command) and the rear-wheel torque command (rear-wheel motor torque command). For example, the final torque command may be distributed only to the rear-wheels (in this case, the final torque command is the rear-wheel torque command), or the final torque command may be distributed to the front-wheel torque command and the rear-wheel torque command with a distribution ratio according to a vehicle driving state.

As described above, a known front- and rear-wheel torque distribution strategy may be used as the torque distribution strategy for the front- and rear-wheels in the non-drift mode, and thus, detailed description thereof will be omitted in this specification.

In the virtual gear shift system, the shift intervention torque can be considered as a type of correction torque for correcting the motor torque to generate and provide the virtual shift feeling. Accordingly, after the demand torque and the motor torque necessary for vehicle driving are determined, the controller 20 corrects the determined motor torque with the shift intervention torque to determine the final motor torque. Here, the final motor torque may be determined by summing the motor torque and the shift intervention torque.

FIG. 2 shows an example in which the shift intervention torque is determined and applied as a negative (−) torque during virtual upshifting in the non-drift mode. FIG. 3 shows an example in which the shift intervention torque is determined and applied as a positive (+) torque during virtual upshifting in the non-drift mode. When the positive (+) torque is used as the shift intervention torque during virtual upshifting, a push-feel type virtual shift feeling may be implemented and provided.

As described above, in some implementations, in a case where there is a virtual shift demand in the non-drift mode, when changing the motor torque from a target torque before shift to a target torque after shift in the shift section, the shift intervention torque for implementing the virtual shift feeling is determined and generated, and then, is reflected in the motor torque.

On the other hand, in a case where there is a virtual shift demand during the drift operation, as shown in FIG. 4, in the shift section, the determination and generation of the existing shift intervention torque is stopped, and the motor torque is changed to a predetermined slope.

FIG. 4 illustrates a torque control state during virtual upshifting in the drift mode. In a case where there is a virtual shift demand during the drift operation, in the shift section in which the target torque before shift transitions to the target torque after shift, the motor torque is determined as a torque value that linearly changes (increases or decreases) with a predetermined slope from the target torque before shift to the target torque after shift, by the controller 20.

Here, as described above, when implementing the torque change that occurs due to the discontinuity in the torque range for each gear shift step, a method of processing the drive system torque using a slope limit (rate limit) or a filter is used, so that the torque is changed slowly on the time axis.

In this way, in the virtual shift section during the drift mode operation, the method of not generating the shift intervention torque at all may be used, but a method of applying a drift mode-dedicated shift intervention torque obtained by multiplying the existing shift intervention torque value by a drift mode-dedicated weight may be used.

The example of FIG. 4 shows that the weight is 0. In a case where the weight is 0, the method described with reference to FIG. 4, that is, the motor torque may be determined by the method of performing the toque transition from the target torque before shift to the target torque after shift according to the slope determined on the basis of the vehicle driving state.

In some implementations, in a case where there is the virtual shift demand in the drift mode, a method of stopping the determination and generation of the existing shift intervention torque in the shift section, suppressing the torque transition by preferentially maintaining the motor torque as the target torque before shift, and gradually changing, in a case where there is a change in the accelerator position sensor value (APS value), the motor torque to the target torque after shift according to the change in the accelerator position sensor value may be used.

Here, suppression of torque transition means keeping the motor torque constant at the target torque before shift until there is the change in the accelerator position sensor value that indicates the vehicle driving state.

In addition, in a state where the motor torque is kept constant as described above, in a case where there is the change in the accelerator position sensor value, the motor torque is changed with a slope determined on the basis of the accelerator position sensor value. Here, the slope of the change (change rate) in the motor torque may be determined as a value corresponding to the slope of change (change rate) in the accelerator position sensor value.

In order to cope with the torque discontinuity in transitioning the motor torque from the target torque before shift to the target torque after shift, a drift-dedicated torque control method during virtual shifting is a method of preferentially maintaining the target torque before shift and gradually performing the transition of the motor torque to the target torque after shift according to the driver's accelerator position sensor value.

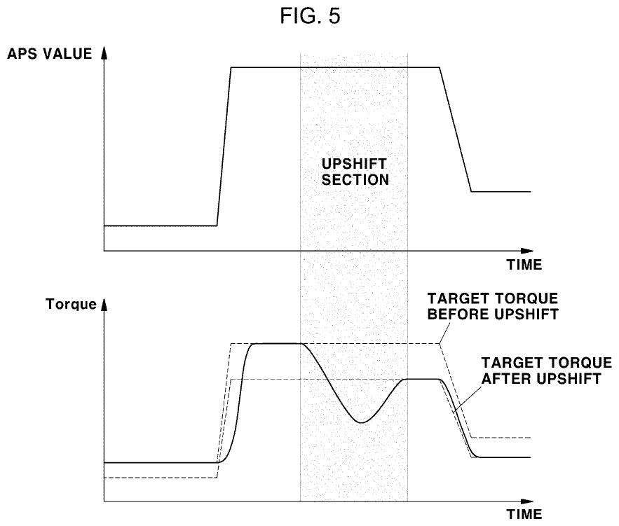

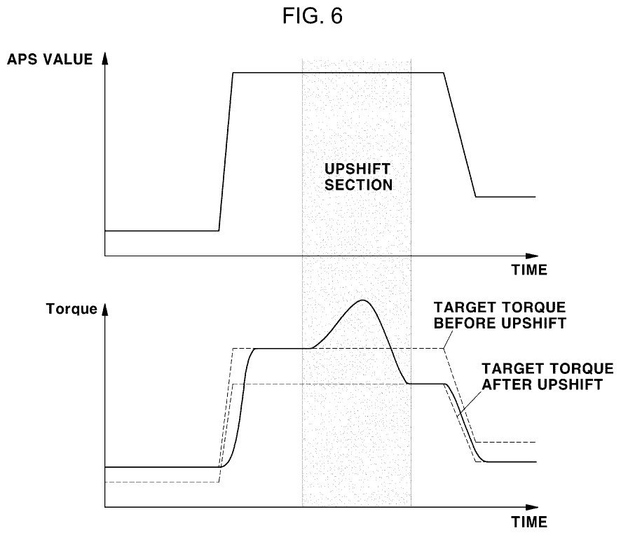

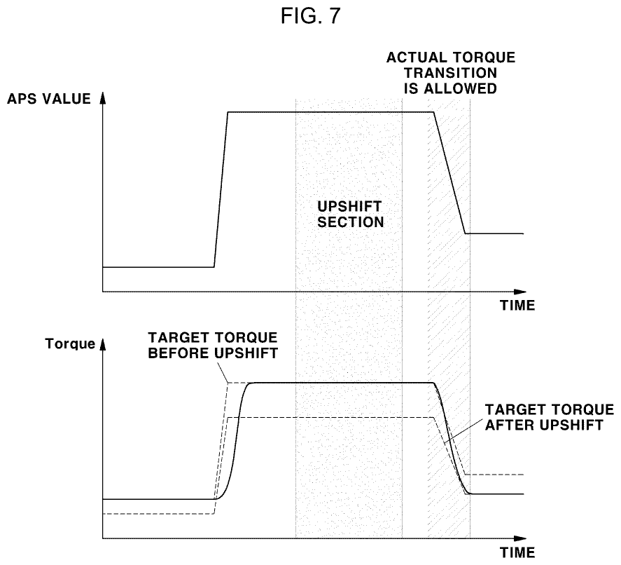

FIGS. 5 and 6 are diagrams showing another example of the drive system torque control state during virtual shifting in the non-drift mode in the drive system torque control method. FIG. 7 is a diagram illustrating a drive system torque control state during virtual shifting in the drift mode in a drive system torque control method.

FIGS. 5 to 7 show examples of upshifting, and show a case where there is an additional change in the driver's accelerator position sensor value after the shift section, compared with the examples of FIGS. 2 to 5.

As in the examples of FIGS. 2 and 3, in a case where there is a virtual shift demand in the non-drift mode, in changing the motor torque from the target torque before shift to the target torque after shift, the shift intervention torque is determined and generated in the shift section that is a torque transition section, and the shifting intervention torque is reflected in the target torque before shift to change the motor torque to the target torque after shift.

Further, in a case where there is a change in the accelerator position sensor value after changing the motor torque to the target torque after shift, the target torque is determined on the basis of information on the gear shift step after shift and the accelerator position sensor value, and the motor torque is controlled to the determined target torque.

On the other hand, when there is the virtual shift demand in the drift mode, the controller 20 suppresses the torque transition by maintaining the motor torque at the target torque before shift in the shift section, and then, in a case where there is a change in the accelerator position sensor value (APS value), the controller 20 gradually changes the motor torque to the target torque after shift according to the accelerator position sensor value.

Further, in changing the motor torque after the change in the accelerator position sensor value (APS value), the controller 20 applies slope limitation to the motor torque. Here, a slope limit value may be determined as a value corresponding to the amount of change or a change slope of the driver's accelerator position sensor value.

In other words, the slope limit value may be determined as a function of the change amount or the change slope of the driver's accelerator position sensor value. To this end, setting data, in which a correlation between the slope limit value and the change amount or the change slope of the driver's accelerator position sensor value is defined in advance, may be input and stored in the first controller 21, and may be used to determine the slope limit value on the basis of the driver's accelerator position sensor value by the first controller 21.

In the setting data, the slope limit value may be set to a smaller value so that the torque transition can be further suppressed as the change amount or change slope of the driver's accelerator position sensor value is absent or smaller (torque transition suppressed direction). Further, the slope limit value may be set to a larger value so that, as the change amount of the driver's accelerator position sensor value increases or the driver's accelerator position sensor value changes more rapidly, more torque transition can be allowed (torque transition allowed direction).

In addition, the slope limit value may be set as a function of the driver's accelerator position sensor value itself. In this case, the larger the accelerator position sensor value, the smaller the slope limit value may be set, and the smaller the accelerator position sensor value, the larger the slope limit value may be set (torque transition allowed direction).

The driver's accelerator position sensor value may also be replaced by the driver's demand torque. Here, the slope limit value for controlling the slope of the motor torque in the controller 20 may be determined to decrease as the driver's demand torque increases, or may be determined to decrease as the amount of change in the driver's demand torque or the slope of the driver's demand torque decreases.

Through this setting strategy, it is possible to effectively reflect the driver's intention to secure a slip margin and induce additional rapid slip at the same time, in upshifting. This is applicable to all shift classes, such as upshift or downshift, power-on and power-off.

Next, in some implementations, in transitioning the torque range for each gear shift step, a method of associating torque transition with the amount of rear-wheel slip may be used. In order to cope with the above-mentioned torque discontinuity, a method of generating a drift mode-dedicated shift intervention torque according to the present disclosure is to associate whether the torque transition is to be allowed with the amount of rear-wheel slip.

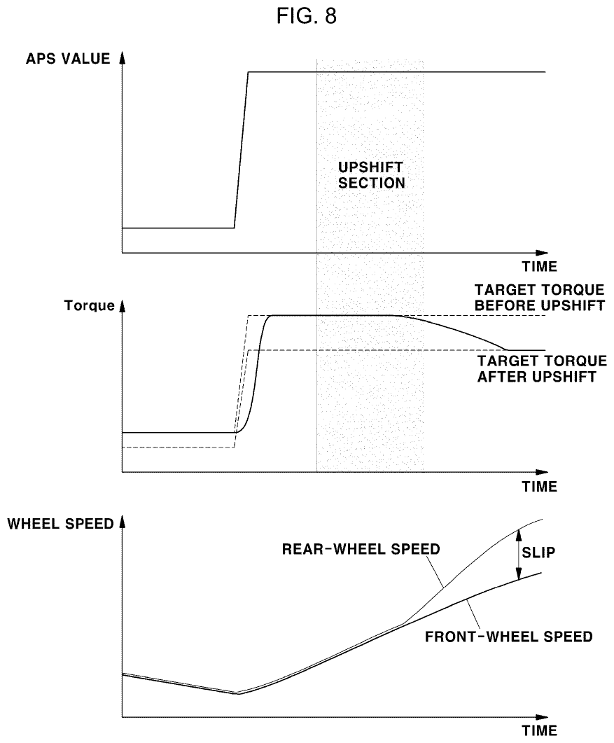

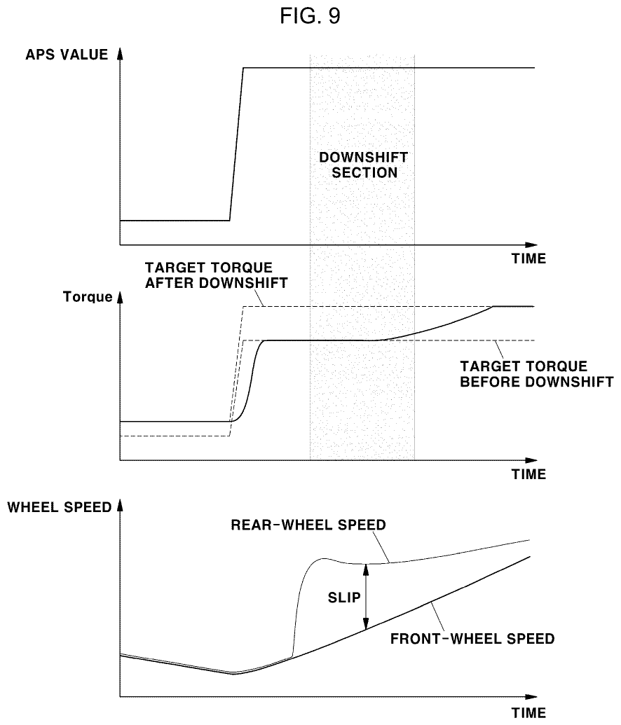

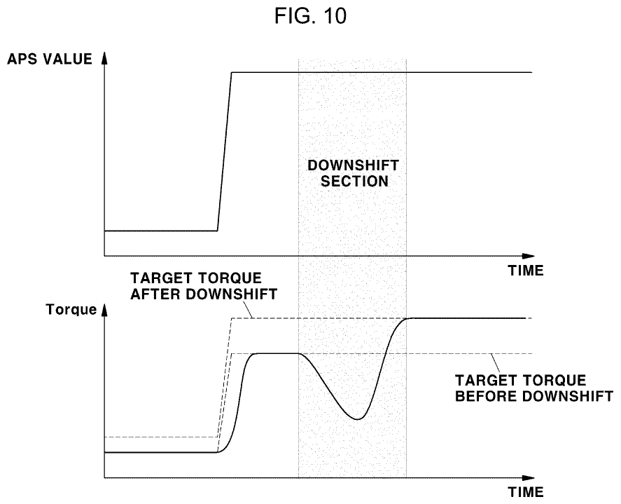

FIGS. 8 and 9 are diagrams illustrating a drive system torque control state during virtual shifting in a drift mode in a drive system torque control method. FIG. 8 shows a case of upshifting, and FIG. 9 shows a case of downshifting. FIG. 10 is a diagram showing still another example of the drive system torque control state during virtual shifting in the non-drift mode in the drive system torque control method according to the present disclosure.

In most cases, in the drift mode, the ease of slip induction must be provided and secured to the driver continuously. Accordingly, it may not be desirable to limit the ease of slip induction by reducing the torque range as soon as upshifting is performed. Alternatively, unintentional convergence of rear-wheel slip due to a negative (−) shift intervention torque generated during downshifting should be prevented.

Accordingly, in a case where the torque range discontinuity occurs due to a shift event, a method of applying a torque range capable of providing a larger torque among the torque range before shift and the torque range after shift as the slip amount decreases, and conversely, applying a torque range capable of providing a smaller torque among the torque ranges as the slip amount increases may be used to enhance the ease of slip control.

Accordingly, in some implementations, in a case where there is a virtual shift demand in a mode that is not currently the drift mode, that is, in the non-drift mode, the shift intervention torque for implementing a normal virtual shift feeling is determined and generated, and then, is reflected in the motor torque. Then, the operation of the motor is controlled using the motor torque in which the shift intervention torque for implementing the virtual shift feeling is reflected as a command value (see FIG. 10), and in a case where there is the virtual shift demand during the drift mode operation, the generation and reflection of the shift intervention torque is stopped.

However, in some implementations, the torque transition is associated with the amount of rear-wheel slip (see FIGS. 8 and 9). That is, in the process of transitioning the motor torque from the target torque before shift to the target torque after shift, the torque slope limit or the filter is applied. Here, the controller 20 may determine the slope limit value or the filter constant value using setting data such as a look-up table or a map in which vehicle driving information including the amount of rear-wheel slip is used as an input variable.

Here, the setting data defines the correlation between the vehicle driving information such as the slope limit value or filter constant value and the amount of rear-wheel slip, in which the slope limit value or the filter constant value is set as a value corresponding to the vehicle driving information such as the rear-wheel slip amount.

In some implementations, in the setting data, in the case of upshift, the slope limit value or the filter constant value may be set to a smaller value so that the torque transition can be further suppressed as the rear-wheel slip amount decreases. Conversely, in the setting data, the slope limit value or the filter constant value may be set to a larger value so that, as the rear-wheel slip amount increases, more torque transition is allowed. Here, the filter constant value may be a filter cutoff frequency.

Conversely, in the case of downshift, since the torque range after shift is advantageous in providing larger torque, in the setting data, the slope limit value or the filter constant value may be set to a smaller value so that the torque transition can be further suppressed as the rear-wheel slip amount increases, and the slope limit value or the filter constant value may be set to a larger value so that, as the rear-wheel slip amount decreases, more torque transition is allowed.

Further, in addition to the slip amount, the torque transition may be performed on the basis of a change rate (change slope) of the rear-wheel slip amount, or may be performed on the basis of both the slip amount and the change rate of the rear-wheel slip amount.

In using the change rate of the rear-wheel slip amount, since the driver has a high tendency to wish to maintain the slip amount during drifting, in the case of upshift, in the setting data, the slope limit value or the filter constant value may be set to a larger value so that, as the change rate of the rear-wheel slip amount increases in the positive (+) direction (as the more rapidly the rear-wheel slip increases), more downward torque transition is allowed.

In the case of downshifting, in the setting data, the slope limit value or filter constant value may be set to a smaller value so that, as the change rate of the rear-wheel slip amount increases in the positive (+) direction, the upward torque transition can be further suppressed.

Conversely, as the slip change rate in the negative (−) direction increases (as the absolute value of the change rate increases, that is, the rear-wheel slip decreases more rapidly), the limit value or the filter constant value may be set to a smaller value so that the downward torque transition can be further suppressed in the case of upshift, and may be set to a larger value so that more downward torque transition can be allowed in the case of downshift.

In this way, according to the torque control method in the drive system of the electric vehicle according to the present disclosure, it is possible to effectively prevent or otherwise minimize the ease of oversteer control from being lowered due to shift intervention torque in the drift mode.

Further, according to the present disclosure, it is possible to make the shift intervention torque reflect the driver's intention in the drift mode, and to reflect the driver's self-directed shifting intention in the drift mode, thereby enhancing the marketability and USP of the electric vehicle to which the drift mode is applied.

What is claimed is:

1. A torque control apparatus of an electric vehicle comprising:
a driving information detector configured to detect vehicle driving state information;
a controller configured to generate a motor torque command related to a demand torque based on vehicle driving information including the vehicle driving state information; and
a motor configured to operate based on the motor torque command,
wherein the controller is configured to:
determine whether a virtual shift demand exists based on a vehicle driving state within a drift mode, the drift mode referring to the electric vehicle traveling in a drift state,
based on a determination that the virtual shift demand exists, (i) stop determination and generation of a shift intervention torque for implementing a virtual shift sensation and (ii) determine a motor torque by adjusting the motor torque based on a slope determined from the vehicle driving state, transitioning from a pre-shift target torque to a post-shift target torque throughout virtual shifting within the drift mode, and
generate the motor torque command based on the determined motor torque.

2. The apparatus according to claim 1, wherein the controller is configured to:
control the slope of the motor torque by applying a slope limit or a filter, and
determine a slope limit value or a filter constant value for controlling the slope of the motor torque from at least one of a shift progress rate, an accelerator position sensor value, a driver's demand torque, a gear shift step before virtual shift, of a gear shift step after virtual shift.

3. The apparatus according to claim 1, wherein the controller is configured to, based on (i) the virtual shifting being performed, (ii) the motor torque being maintained at the pre-shift target torque, and (iii) an accelerator position sensor value being changed, change the motor torque from the pre-shift target torque to the post-shift target torque according to the slope determined based on one of an accelerator position sensor value or a driver's demand torque.

4. The apparatus according to claim 3, wherein the controller is configured to:
control the slope of the motor torque by applying a slope limit, and
determine a slope limit value to thereby control the slope of the motor torque to (i) decrease as the accelerator position sensor value increases or (ii) decrease as an amount of change in the accelerator position sensor value or a slope of the accelerator position sensor value decreases.

5. The apparatus according to claim 3, wherein the controller is configured to:
control the slope of the motor torque by applying a slope limit, and
determine a slope limit value to thereby control the slope of the motor torque to (i) decrease as the driver's demand torque increases or (ii) decrease as an amount of change in the driver's demand torque or a slope of the driver's demand torque decreases.

6. The apparatus according to claim 1, wherein the controller is configured to change the motor torque from the pre-shift target torque to the post-shift target torque according to a slope determined based on an amount of rear-wheel slip.

7. The apparatus according to claim 6, wherein the controller is configured to:
control the slope of the motor torque by applying a slope limit or a filter, and
determine a slope limit value or a filter constant value to thereby control the slope of the motor torque to, (i) during an upshift, decrease as the amount of rear-wheel slip decreases and, (ii) during a downshift, decrease as the amount of rear-wheel slip increases.

8. The apparatus according to claim 6, wherein the controller is configured to:
control the slope of the motor torque by applying a slope limit or a filter, and
determine a slope limit value or a filter constant value to thereby control the slope of the motor torque to, (i) during an upshift, increase as a change rate of the amount of rear-wheel slip increases in a positive direction and, (ii) during a downshift, decrease as the change rate of the amount of rear-wheel slip increases in the positive direction.

9. The apparatus according to claim 6, wherein the controller is configured to:
control the slope of the motor torque by applying a slope limit or a filter, and
determine a slope limit value or a filter constant value to thereby control the slope of the motor torque to, (i) during an upshift, decrease as a change rate of the amount of rear-wheel slip increases in a negative direction and, (ii) during a downshift, increase as the change rate of the amount of rear-wheel slip increases in the negative direction.

10. A torque control apparatus of an electric vehicle comprising:
a driving information detector configured to detect vehicle driving state information;
a controller configured to generate a motor torque command related to a demand torque based on vehicle driving information including the vehicle driving state information; and
a motor configured to operate based on the motor torque command,
wherein the controller is configured to:
determine whether a virtual shift demand exists based on a vehicle driving state within a drift mode, the drift mode referring to the electric vehicle traveling in a drift state,
generate, based on a determination that the virtual shift demand exists, a shift intervention torque for implementing a virtual shift sensation from the vehicle driving information,
determine a drift mode-dedicated weight according to input information for each virtual shifting situation,
apply the determined drift mode-dedicated weight to the generated shift intervention torque to determine a drift mode-dedicated shift intervention torque, and
generate the motor torque command based on a driver's demand torque and the determined drift mode-dedicated shift intervention torque.

11. A torque control method of an electric vehicle, the torque control method comprising:
determining, by a controller, whether a virtual shift demand exists based on a vehicle driving state within a drift mode, the drift mode referring to the electric vehicle travelling in a drift state;
stopping, based on a determination that the virtual shift demand exists, determination and generation of a shift intervention torque for implementing a virtual shift sensation, and determining a motor torque by adjusting the motor torque based on a slope determined from the vehicle driving state, transitioning from a pre-shift target torque to a post-shift target torque within the drift mode, by the controller; and
generating, by the controller, a motor torque command based on the determined motor torque, and controlling a motor that drives the electric vehicle according to the generated motor torque command.

12. The method according to claim 11, further comprising:
controlling, by the controller, the slope of the motor torque by applying a slope limit or a filter, and
determining, by the controller, a slope limit value or a filter constant value to thereby control the slope of the motor torque from at least one of a shift progress rate, an accelerator position sensor value, a driver's demand torque, a gear shift step before virtual shift, or a gear shift step after virtual shift.

13. The method according to claim 11, wherein determining the motor torque comprises:
based on (i) the virtual shifting being performed, (ii) the motor torque being maintained at the pre-shift target torque, and (iii) an accelerator position sensor value being changed, changing the motor torque from the pre-shift target torque to the post-shift target torque according to the slope determined based on one of an accelerator position sensor value or a driver's demand torque.

14. The method according to claim 13, further comprising:
controlling the slope of the motor torque by applying a slope limit, and
determining a slope limit value to thereby control the slope of the motor torque to (i) decrease as the accelerator position sensor value increases or (ii) decrease as an amount of change in the accelerator position sensor value or a slope of the accelerator position sensor value decreases.

15. The method according to claim 13, further comprising:
controlling the slope of the motor torque by applying a slope limit, and
determining a slope limit value to thereby control the slope of the motor torque to (i) decrease as the driver's demand torque increases or (ii) decrease as an amount of change in the driver's demand torque or a slope of the driver's demand torque decreases.

16. The method according to claim 11, wherein determining the motor torque comprises changing the motor torque from the pre-shift target torque to the post-shift target torque according to a slope determined based on an amount of rear-wheel slip.

17. The method according to claim 16, further comprising:
controlling the slope of the motor torque by applying a slope limit or a filter, and
determining a slope limit value or a filter constant value to thereby control the slope of the motor torque to, (i) during an upshift, decrease as the amount of rear-wheel slip decreases and, (ii) during a downshift, decrease as the amount of rear-wheel slip increases.

18. The method according to claim 16, further comprising:
controlling the slope of the motor torque by applying a slope limit or a filter, and
determining a slope limit value or a filter constant value to thereby control the slope of the motor torque to, (i) during an upshift, increase as a change rate of the amount of rear-wheel slip increases in a positive direction and, (ii) during a downshift, decrease as the change rate of the amount of rear-wheel slip increases in the positive direction.

19. The method according to claim 16, further comprising:
controlling the slope of the motor torque by applying a slope limit or a filter, and
determining a slope limit value or a filter constant value to thereby control the slope of the motor torque to (i) during an upshift, decrease as a change rate of the amount of rear-wheel slip increases in a negative direction and, (ii) during a downshift, increase as the change rate of the amount of rear-wheel slip increases in the negative direction.

20. A torque control method of an electric vehicle, the torque control method comprising:
determining, by a controller, whether a virtual shift demand exists based on a vehicle driving state within a drift mode, the drift mode referring to the electric vehicle travelling in a drift state;
generating, based on a determination that the virtual shift demand exists, a shift intervention torque for implementing a virtual shift sensation from vehicle driving information, by the controller;
determining, by the controller, a drift mode-dedicated weight according to input information for each virtual shifting situation;
determining, by the controller, a drift mode-dedicated shift intervention torque obtained by applying the determined drift mode-dedicated weight to the generated shift intervention torque;
generating, by the controller, a motor torque command based on a driver's demand torque and the determined drift mode-dedicated shift intervention torque; and
controlling an operation of a motor configured to move the electric vehicle based on the generated motor torque command.
